(19) United States
(12) Patent Application Publication
(10) Pub. No.: US 2006/0232778 A1
(43) Pub. Date: Oct. 19, 2006

(54) Sensor system for a ring spinning machine

(76) Inventor: Markus Gneupel, Pfungen (CH)

Correspondence Address: DORITY & MANNING, P.A., POST OFFICE BOX 1449, GREENVILLE, SC, 29602-1449, US

(21) Appl. No.: 10/524,522

(22) PCT Filed: Aug. 12, 2003
(86) PCT No.: PCT/CH03/00543

§ 371 Date: Apr. 27, 2006

(30) Foreign Application Priority Data
Aug. 13, 2002 (CH) 1390/02

(51) Int. Cl. G01N 21/84

(52) U.S. Cl. 356/429

(57) ABSTRACT

A ring frame (113) in a ring spinning machine is provided with an optical sensor for scanning the state of a spinning position. The sensor comprises a light beam transmitter (236) and a light beam receiver (238) for receiving light which is emitted by the transmitter (26) and reflected by a part in the spinning position, in particular from a traveller circulating on a spinning ring. The sensor is characterised in that the transmitter (236) and the receiver (238) are carried by a common carrier (202). The carrier (20) can be provided with a plurality of housings (212), whereby each housing (212) accommodates a sensor (transmitter/receiver pair). The housing (212) is provided for the transmitter (236) and the receiver (238) with a light-permeable part (240, 242) in each case, which can be formed as a optical lens.

The invention relates to a sensor system, in particular for a ring spinning machine with a ring frame. The invention is concerned in particular with the design of components which are intended to make possible the realisation of what is referred to as an individual spindle sensor system.

### PRIOR ART

An overview of the basic known solutions for sensor systems in a ring spinning machine can be derived from the technical article “Sensors for Thread Monitors” in Textiltechnik 34(1984) 3(page 131).

Optical sensors are known from EP-A480 898 and DE-A-2334389.

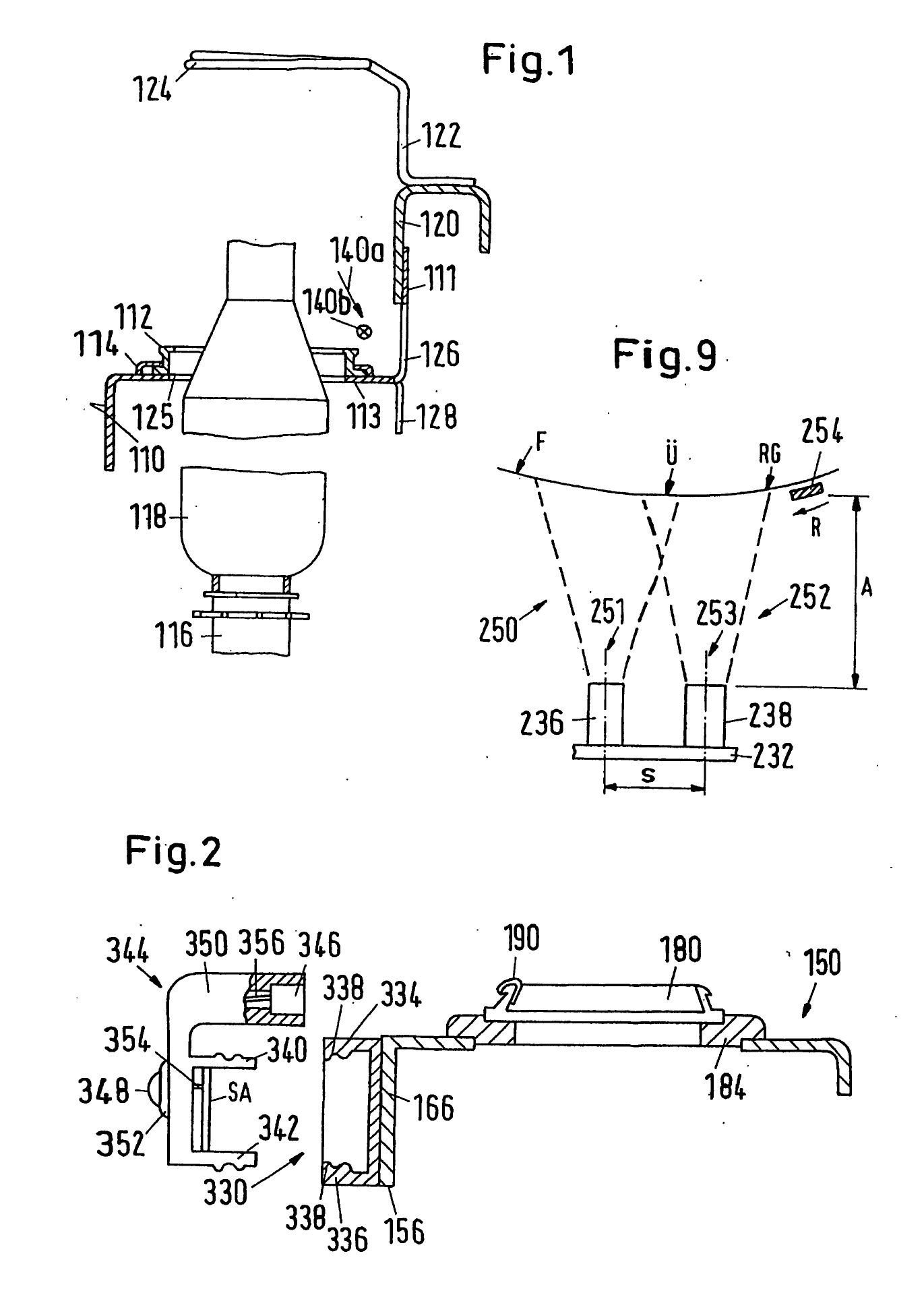

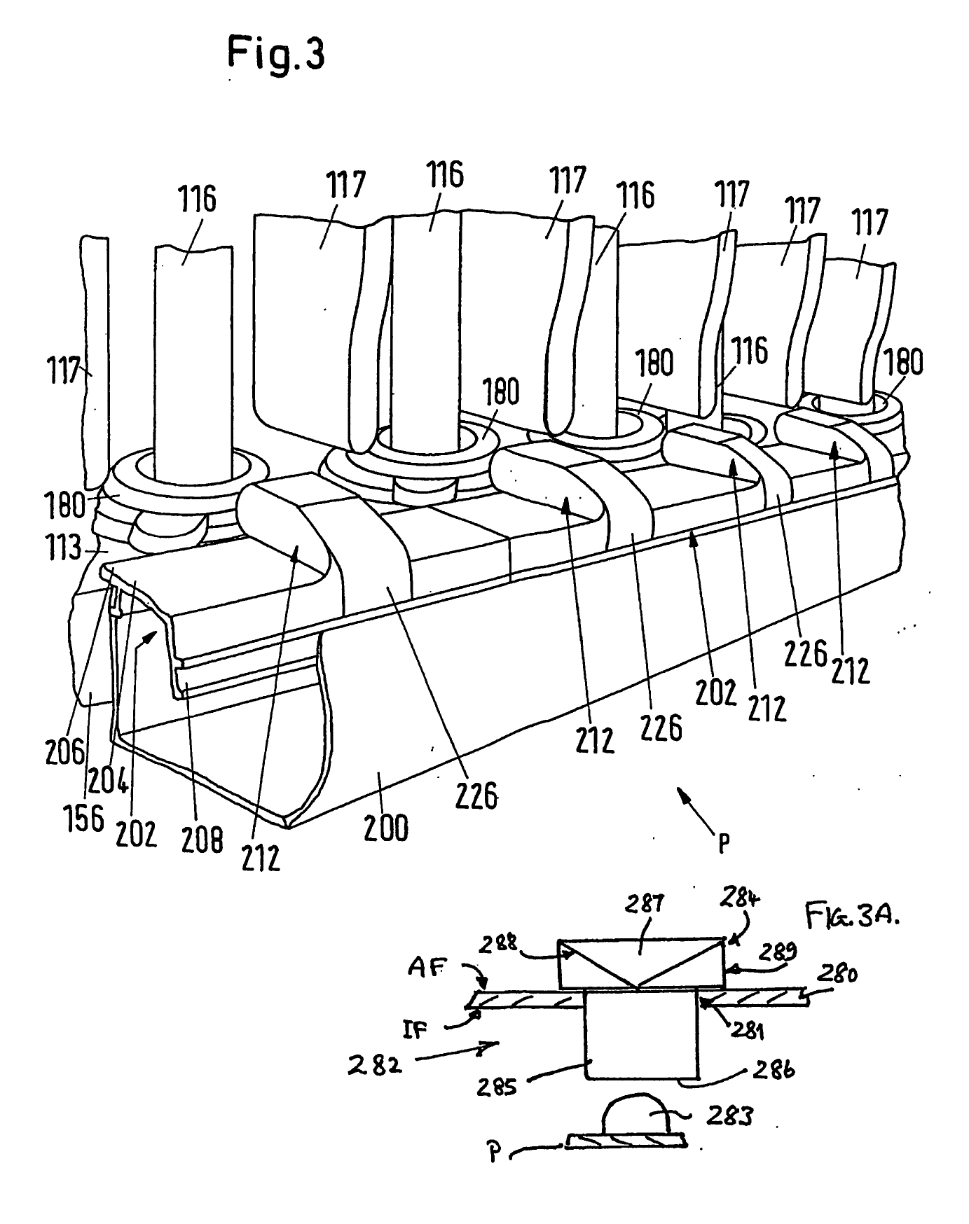

EP-A480898 shows in a principle sketch (FIG. 1) a sensor design which is intended to detect the light being reflected from a traveller, as well as two sensor designs (FIG. 2 and 3 respectively), which operates by means of the interruption of a light beam by a moving element (e.g. traveller or thread) in a spinning position. For the designs which operate on the basis of the interruption of a light beam, not only principle sketches are shown and described but also construction design details. For the arrangement according to FIG. 1, however, in EP-A480898 only the principle sketch is provided.

According to the Description of FIG. 1, EP-A480 898, the transmitter and receiver heads of FIG. 1 are to be located individually at the ring frame. In a ring spinning machine with (today) more than 1000 spinning positions, such a procedure is excluded for economic reasons.

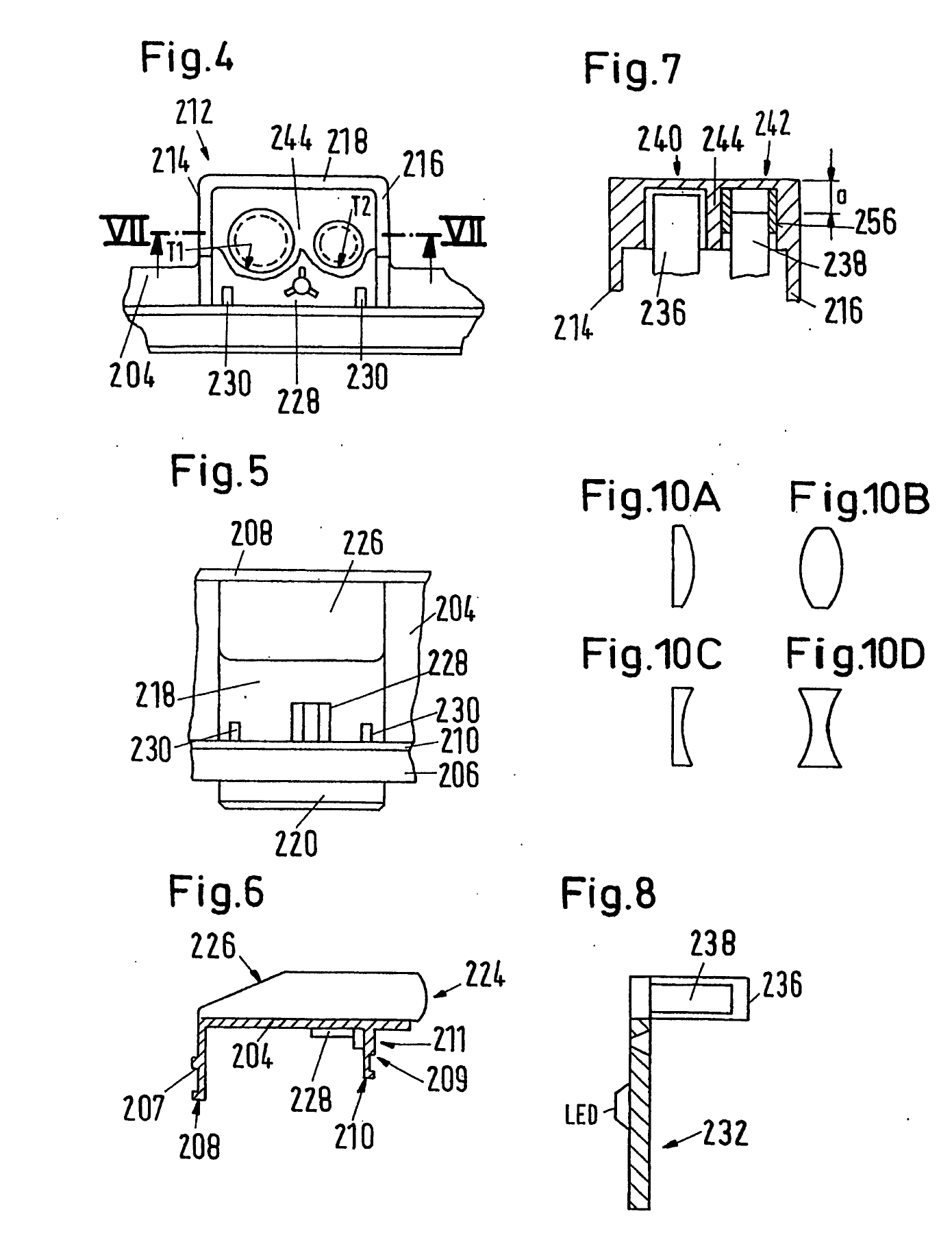

In FIGS. 4 to 6 of EP-A480 898 a mounting unit for the design embodiment according to FIG. 2 in the same text is shown. This unit comprises a U-shaped hollow profile, which is intended to grip the individual sensors in an elastic manner. The heads can be pushed along the profile, in order to allow for the adjustment of the individual distance interval from the spinning ring, i.e. the open profile is not covered and will collect fibre fly and dirt during operation. A comparison with the corresponding principle sketch (FIG. 2 in EP-A-480 898), however, makes it immediately clear that the construction design according to FIG. 4 to 6 does not represent a practically feasible solution to the realisation of this principle; according to the principle, a light beam should pass close by at the spinning ring, which, because of the dimensions of the elements in FIGS. 4 to 6, appears to be impossible. It is in any event not clear how the hollow profile were to be located at the ring frame according to FIG. 4 if, at the same time, the operating conditions according to FIG. 2 are to be fulfilled. It is therefore illuminating that the Applicants, in connection with EP-A-480898, have in practice not realised either of the two designs according to FIGS. 1 and 2, but only the entirely different variant according to FIG. 3.

EP-A480898 also mentions DE-A-2334389 as a prior publication of an optical sensor, which can be provided for in the form of a light barrier or a reflection head. DE-A-2334389 is not primarily concerned with sensors, however, but rather with a revolution speed regulating device for a ring spinning machine. An optical sensor is only mentioned as one variant among others, and it already becomes clear from the schematic representation (FIG. 3) of such a sensor that little thought has been given to the realisation.

The problem of this invention is to propose components which allow for the use of what is referred to as a reflection head in the individual spindle sensor arrangement of a ring spinning machine.

The problem is resolved by the Features of Claim 1.

The claimed solution offers the advantage that the (opposed) geometric relationships of the transmitter and receiver elements of a spinning position can be predetermined and the final installation thereby rendered easier.

The present invention can be used in combination with the invention according to EP-A-1052314 and/or EP-A-1074645.

Certain features of the embodiment examples in these applications, however, must be adapted for this purpose.

Embodiments of the invention are described in detail hereinafter on the basis of the Figures. These show:

FIG. 1A cross-section through a ring frame with the surrounding parts of a ring spinning machine according to DE-A-195 42 802;

FIG. 2A copy of FIG. 11 from EP-A-1074645;

FIG. 3A perspective representation in diagrammatic form of a solution according to the present invention, whereby parts have been broken off in order to be able to represent the parts located beneath;

FIG. 3aA modification of the arrangement according to FIG. 3;

FIG. 4A detail (a housing) from FIG. 3 seen in the direction of the arrow P (FIG. 3), whereby a part of the housing has been left out, in order to show the cavity inside the housing;

FIG. 5 The housing from FIG. 4 seen from below;

FIG. 6 The housing from FIGS. 4 or 5 respectively, seen from the side;

FIG. 7A detail in cross-section from FIG. 4 in the plane VII-VII;

FIG. 8A electronics board in diagrammatic form in a side view;

FIG. 9 The geometry of the optical system in diagrammatic form;

FIG. 10 Different variants (FIGS. 10A to 10D) of a lens optics arrangement for a housing according to FIGS. 4 to 7.

First the design of the ring frame of a ring spinning machine and the solution according to EP-A-1074645 are considered, after which an embodiment of a carrier according to the invention will be explained.

The ring frame 110 in FIG. 1 presents a horizontal contact part 113 for a spinning ring 112, as well as a support part 111 pointing towards the inside of the spinning machine, to which a rail 120 is secured, which carries a holder 122 and a ring 124 for the checking of the thread balloon. It is understood that allocated to each spindle 116 with its cop 118 in a hole 125 of the ring frame 110 are a spinning ring 112, a holder 122, and a further ring 124. A spinning ring 112 is secured by a holding device 114 at the ring frame.

For directing air flows, penetration apertures 126 and strips 128 are provided in the support part 111, which pass out beneath the contact part 113 of the support part 111.

The penetration apertures 126 allow for the deflection of the air flowing along the cops according to the arrows 140a, 140b. The ring frame according to FIG. 1 is simply shown as an example; the actual design does not play any significant part for this invention.

The ring frame 150 in FIG. 2 carries a spinning ring 180, with a traveller 190 and ring holder 184. The spinning ring represented in FIG. 2 is formed as what is referred to as an “oblique flange ring” (e.g. in accordance with EP-B-528 056). The invention can, however, also be used with other ring types (e.g. with the conventional ring cross-section according to FIG. 1). Secured by appropriate means (not shown) on the front side 156 of the ring frame is a base part 330. The base part comprises two walls 334, 336 projecting from the ring frame, whereby each wall is provided with an inner bulge 338 at the end removed from the ring frame. The bulge 338 form a snap connection with connecting elements 340, 342 of a holding device 344 for a magnetic traveller sensor 346. The holding element 344 can be formed from plastic. It also comprises a mounting 352 for a signal lamp 348.

The connection elements 340, 342 also serve as securing elements for a signal evaluation unit SA, which is connected by means of leads 354, 356 to the display 348 and the sensor 346. The holding element 344 therefore also serves as a part cover for the channel inside the base 330.

According to EP-A-1074645, the sensor 346 is designed for preference as a magnetic sensor. This design has also proved its value in technical terms. It has transpired, however, that this choice of sensor element exerts a determinant influence on the overall costs, and that it is very difficult for the end product (1000+ sensors with evaluation electronics, cabling, and operating guide system) to be offered at a price which is attractive for the purchaser of the ring spinning machine. Optical sensors can be purchased more cheaply. As has already been shown in the introduction, however, there has hitherto been no design known to the Applicants with reflection heads as traveller sensors.

In FIG. 3, parts of four adjacent spindles 116 of a ring spinning machine and a small part of the contact surface 113 of the ring frame of this machine can be seen. The parts 117 are what are referred to as the “separators”, which as far as possible screen the surroundings of a spindle 116 (a “spinning position”) from the surroundings of the adjacent spindles 116 (“spinning positions”). Parts of the spinning rings 180 for five spinning positions can also be seen in this Figure.

Secured to the front face 156 (only visible on the left) of the ring frame is a U-shaped profile 200, which, like the base part 330 (FIG. 2), forms a part of a channel. In the representation according to FIG. 3, the profile 200 is broken away at the end, in order to show the ring frame lying beneath. The nature of the securing arrangement is not particularly important, because the system, which is still to be described, is not sensitive to minor tolerance errors.

The fitting of the profile should, however, be carried out in such a way that the upper (left) edge of the profile 200 lies in one plane with the contact surface 113. The profile 200 is open to the top, and the channel is therefore closed by cover elements (“sensor carriers”) 202 according to the present invention, whereby in FIG. 3 two cover elements are partially illustrated.

Each cover element 202 comprises a cover plate 204, of which one edge strip 206 lies on the contact surface 113, and two elastic securing strips 208, 210, which project downwards into the channel and form a snap connection with the side walls of the profile 200. The securing strip 208 forms the lower part of a wall, which exhibits a stop 207, and the strip 210 forms the lower part of a wall 211 which exhibits a stop 209. The stops 207, 209 come into contact with the free edges of the profile 200, and so define the angle setting of the cover plate 204 in relation to the contact surface 113.

Each cover plate 204 carries four housings 212, whereby in FIG. 3 only one housing 212 of the left cover element 202 and three housings 212 of the right cover element 202 are visible. The angle settings of the housing in relation to the contact surface 113 and in relation to the spinning rings mounted on the contact surface, are provided by the angle setting of the cover plate 204 in each case. The housings 212 are described in greater detail hereinafter on the basis of FIGS. 4 to 7, whereby they are all identical, so that the description of the one housing applies to all the others.

Each housing 212 comprises two side walls 214 to 216 respectively (FIG. 4) and a cover part 218. Inside the channel 200, the housing is designed-without a floor, i.e. it is entirely open towards the cavity of the channel. The side walls 214, 216, however, project outwards over the edge strip 206 and are connected in this projecting area (in the “front part” of the housing) by a floor 220 (FIG. 5), so that the housing 212 is closed to the outside. The “front face” 224, i.e. the housing wall, which is located opposite a spinning ring 180 allocated to this housing, is formed especially according to the teaching of certain Sub-claims, and is explained in greater detail hereinafter. First, however, the description of the general construction design of the housing will be concluded.

The “rear face” of the housing 212, i.e. the housing wall, which is located opposite the operating aisle between two adjacent machines, is formed by a curved wall part 226, which has been removed in FIG. 4 in order to allow for insight into the cavity of the housing. Inside the channel, the wall 211 is provided with a suspension element 228 and two stops 230. By means of these elements, an electronic printed circuit board 232 according to FIG. 8 can be mounted in a predetermined position opposite the front face 224 of the housing.

The electronic printed circuit board 232 is in its basic concept similar to the printed circuit board which was described in connection with EP 1074645 (FIGS. 12 and 13 respectively); i.e. it comprises a carrier with a computer and lead paths between the computer and other electrical elements of the electronics system. Because these elements and leads are not in themselves of significance for this invention, they have not been shown. This printed circuit board has, however, been provided with an aperture 234, which can accommodate the suspension element 228 when the printed circuit board 232 is pushed “forwards” (in the direction of the front face 224). The printed circuit board 232 should be pushed so far forwards that it comes in contact against the stops 230. The aperture 234 and the suspension element 228 are designed in such a way that a certain clamping force pertains between them when the printed circuit board 232 is in contact with the stops 230.

The position of the printed circuit board inside the housing is therefore 212 specified. It should be emphasised that this securing arrangement for the printed circuit board is by no means of importance for the invention. For preference, the securing arrangement is secure enough to guarantee the positioning of the printed circuit board against shaking (vibrations), but nevertheless to allow for the removal of the printed circuit board from the housing for the purpose of replacement. The securing of the printed circuit board can be guaranteed, for example, by the simple stops 230 being changed to elastic elements, which together with the edge parts of the printed circuit board form the snap connection.

The printed circuit board 232 differs from the printed circuit boards of EP-A-107645 in that it is equipped with a light transmitter element 235 (FIG. 7), a light receiver element 238 (FIG. 7 and FIG. 8), and a light-emitting diode LED as a signal generator for the operating guide system. As can be seen from FIG. 7, the transmitter element 236 is accommodated in a “pocket” 240 provided for this purpose in the front part of the housing, when the printed circuit board 232 is in contact with the stops 230, while the receiver element 238 is accommodated in an adjacent “pocket” 242. The pockets 240, 242 can also be seen in FIG. 4. The diode LED, by contrast, is located on the other side of the printed circuit board and is located opposite the wall part 226.

There are various different light transmitter-receiver elements on offer on the market, and they are normally provided with their own individual optics systems for bundling the transmitted and received light beams respectively. It is possible for a transmitter/receiver element pair to be found, which, apart from light permeability, does not impose any special demands on the front face 224. This happy combination is improbable, however, as a consideration of the broader problems in connection with the application provided for in the ring spinning machine will show. These boarder problems are reproduced here only by way of summary headings:
Spinning ring diameter is variable
Ring material and ring surface quality variable
Traveller material and ring surface quality variable
Traveller shape and position (geometry) variable in relation to the ring
Traveller speed variable
Minimum distance interval between the spinning ring and the housing important (operating of the spinning position and, under certain circumstances, interference with the traveller movement, if the distance interval is too small)
Light conditions variable (daylight/artificial lighting, shadowing of the spinning position, etc.)
Ageing of the components
Dirt contamination (deposits, fabric fly, etc.)

In addition to this, no economical solution has been provided for the system to be adjusted individually to each individual application possibility, in particular due to the fact that the adaptation work in most cases would have to be carried out by the end users, which would incur a market disadvantage for the suppliers.

It is therefore no essential to the invention, but very advantageous, for an optical arrangement to be provided for in the front face itself, which favours the flexibility of the solution in relation to uncontrollable changes in the environment. The design of the front face should therefore be explained as the next point.

An individual “window” 240, 242 (FIG. 4 and FIG. 7) is provided in the front face 224 for both the transmitter 236 as well as for the receiver 238. These windows 240, 242 are at least selectively “light-permeable”, i.e. they allow through the beam which is emitted by the transmitter and which is intended to be detected again by the receiver.

According to certain definitions (see Dubbel), light-measuring technology is concerned with “visible radiation in the wavelength range λ=380 nm (blue) to 780 nm (red)”. The term “light” in this Description, however, is not restricted to the visible electromagnetic oscillations. The term in this situation also encompasses the low-energy forms of radiation, which can also be put to use in the monitoring of machines operated by people, in particular the ranges of the infra-red and ultra-violet spectra adjacent to the visible range. The transmitter 236 in the embodiment according to FIGS. 4 to 7 emits radiation for preference in the infra-red range, for example with a wavelength in the order of magnitude of 850 nm to 950 nm. It is entirely possible, however, for light in the visible range to be used, in particular if a laser has been selected as the transmitter element.

The term “light permeable” in this situation, however, does not mean absolute transparency. A certain attenuation (absorption) of the emitted energy is permissible, provided that the receiver exhibits sufficient sensitivity. The material of the window can be selected in such a way that it creates a filter effect and therefore allows through certain wavelengths (which are predetermined by the selection of the transmitter). The material could, for example, be selected in such a way that it is practically impermeable to wavelengths outside the infra-red range. This additional measure is, however, not essential to the invention.

The wall parts adjacent to the windows exhibit in any event, for preference, a relatively low light permeability. This applies not only to the side walls 212, 214 and the roof part 218, but also to the partition wall 244 between the “pockets” which accommodate the transmitter 236 and receiver 238. As a result of this measure, a “short-circuit” (crosstalk) between the transmitter 236 and the receiver 238 is counter-acted. The relative permeability of the wall parts does not necessarily have to be provided by the choice of the material, but can (also) be determined by the wall thickness. For preference, both measures (choice of material as well as choice of wall thickness) are used in order to achieve the effect required. The front part of the housing is for preference formed from one single material and, to the purpose, is formed in one piece. The preferred material is a plastic, for example a polycarbonate. The windows can present a wall thickness in the range from 0.5 to 1.5 mm, while the relatively impermeable wall parts have a substantially greater thickness.

The diode LED is intended to emit visible light, since this element serves as a part of the operating guide system. The concept of the operating guide system has already been explained in EP-A-1074645 (FIGS. 8 to 10), and the description will not be repeated here. What is important for this system is a signal which is visually perceivable, which shows that a fault has arisen at a spinning position concerned. In other words, the housing 212 should not serve as a display means.

In the design embodiment according to FIG. 3 of this Application, the signal is generated by the diode LED lighting up. The rear wall 226 must therefore be light-permeable, and, specifically, permeable to visible light.

Within the framework of the guide concept described in EP-A-1074645, however, it is not advisable for the entire rear part of the housing 212 to be designed as transparent. The alarm or call signal which is emitted by a specific spinning position should only be perceivable by an operator person within a predetermined spatial area around this spinning position, and the side walls 214, 216 in the rear part of the housing 212 are therefore essentially impermeable to the radiation which is emitted by the diode LED. The shape of the side walls 214, 216, especially in the rear part of the housing, is selected in such a way in relation to the position of the diode LED inside the housing that an operator person will only perceive the signal when it enters the specified recognition field in the vicinity of the spinning position.

On the basis of FIG. 9, the “geometry” of the sensor arrangement in a spinning position according to FIG. 3 will now be explained. The printed circuit board 232, the transmitter 236, and the receiver 238 are also shown in FIG. 9. The housing 212 has been left away, because it is assumed that the windows 240, 242 behave in a radiation-permeable manner, while the partition wall is impermeable to radiation. The transmitter is provided by the manufacturers with its own optical arrangement, so that this element produces a beam 250 (indicated by the broken line), which expands in conical form and asymmetrically about an axis 251. The receiver 238 naturally does not produce a beam, but it has a “sensor field” allocated to it which likewise expands conically and asymmetrically about an axis 253 as its distance from the receiver increases; the conical expansion of this sensor field is indicated by 252 in the form of broken lines in FIG. 9. It is assumed in the first instance that the axes 251, 253 run mutually parallel with a distance intervals. The figure does not show the angle setting of the axes 251, 253 in relation to the contact surface 113; it is assumed that the axes run parallel to the surface 113.

A segment of the “surface” of the spinning ring 180 is indicated in FIG. 9 by F. This segment is located, according to FIG. 9, at a distance interval A from both the transmitter 236 as well as the receiver 238. The reference number 254 indicates a limb of the traveller 190, which moves from the spinning ring 180 guided in the direction of the arrow R. It is assumed that the traveller 190 penetrates at the moment To into the sensor field of the receiver 238. This penetration does not initiate any change at all in the state of the receiver 238 or the sensor system, because the peripheral area RG, in which the traveller 190 first penetrates into the sensor field 252, is not irradiated by the transmitter 236. It is only when the limb 254 penetrates into the area Ü, in which the sensor field 252 of the receiver 238 overlaps the cone 250 of the transmitter 236, that the sensor system reacts (can react) to the traveller 190.

When observing this diagram, consideration may be given to the notion of “optimising” this geometry. The axes 251, 253 could, for example, approach near to one another in the direction of the spinning ring, and in any event intersect at a point on the segment F. The distance interval s should be kept as small as possible, without the risk of a “short-circuit” (crosstalk, or direct transfer from the transmitter to the receiver). The distance interval A must also be kept small.

There are, however, limits to these attempts at optimisation. For technical spinning reasons, the distance interval A cannot be selected as too small. In the first place, the housing 212 approaching close to the spinning ring 180 could cause a disturbance in the thread run, and, in addition, this approach is limited by the need to be able to operate the spinning position. A distance interval A of less than 10 mm is therefore problematic in all cases, and is therefore for preference to be avoided. For preference, this distance interval amounts to more than 15 mm, and for preference a distance interval is of 20 mm or more. With an increasing distance interval A, however, the angle setting of the axes 251, 253 in relation to the contact surface 113 increases in significance. The greater the distance interval A is chosen to be, the more precisely this angle setting must be determined, in order to avoid the beam 250 either falling onto the surface 113 in front of the spinning ring, or expanding uselessly above the spinning ring in the area of the thread balloon.

An attempt at optimisation will in many cases come to nothing, however, because it must be assumed that the spinning position circumstances will change during the service life of the sensor system, e.g. because a conventional spinning ring (112, FIG. 1) is replaced by an oblique flange ring (190, FIG. 2), and/or because a spinning ring of a given diameter is replaced by a spinning ring of another diameter. The diameter of the spinning ring in a ring spinning machine can be selected by the end user for the processing of short-staple fibres normally in the range from 35 to 50 mm. The machines which process long-staple fibres operate with ring diameters of considerable size.

The radiation-emitting surface of the transmitter 236 should be located as close as possible to the window 240 (FIG. 7), without coming in contact with the window 240. There should not be any substantial distance interval left between the transmitter 236 and the inner face T1 (FIG. 4) of the transmitter pocket. It is therefore to advantage for the surface T1 to be designed with a small conicity, so that the transmitter 236 comes in contact with the surface T1 shortly before it would touch the window. A conical course of the surface T1 of this kind is indicated diagrammatically in FIG. 4 by means of a broken-line circle.

The light-sensitive surface of the receiver 238 exhibits for preference a somewhat greater distance interval to the overlap area Ü than the distance interval A from the transmitter 236. This can be guaranteed by a smaller distance interval a (FIG. 7) being left free between the light-sensitive surface of the receiver and the window 242.

This can also be guaranteed if the receiver 238 comes in contact with a conical surface T2 (indicated diagrammatically by broken lines, FIG. 4) of the reception surface and/or that the receiver 238 is provided with a cover 256 (FIG. 7), which comes in contact with the window 242.

In order to increase the light yield, the window 242 and/or the window 240 can be designed as a lens. Different types of lenses are possible, whereby FIG. 10 shows the following examples:

FIG. 10A Outer surface convex, inner surface lying in a plane (plano-convex lens);

FIG. 10B Outer surface convex, inner surface likewise convex;

FIG. 10C Outer surface concave, inner surface likewise concave;

FIG. 10D Outer surface concave, inner surface lying in a plane (plano-concave lens).

The word “outer surface” relates to the surface which is located on the outside of the housing 212. The “inner surface” lies inside the cavity of the housing 212. The curvature of the outer surface can, but does not necessarily have to be, the same for both lenses (windows) 240, 242, i.e. for the transmitter as well as for the receiver.

These examples are not to be understood as exclusive choices, but are intended to illustrate the range of possible choices. The optimum shape for a given application should be determined empirically. By exploiting this possibility the maximum possible distance interval A for otherwise given circumstances can be increased, without falling beneath a traveller recognition threshold of the sensor system. A further possibility pertains in incorporating a lens in the housing 212. This, however, requires the formation of a lens mounting in the housing 212 and the installation work for fitting the lenses into this mounting, which can be avoided by integrating the lenses into the housing structure itself.

In the preferred embodiment, the housing 212 forms what is referred to as a multi-functional monolithic housing. As a minimum, the functions of protection and/or positioning and/or light bundling can be integrated in this monolithic housing, but for preference also the display function, which shows up a defective spinning position. The display can be designed in such a way that it displays both a thread break, as well as a spindle with an incorrect speed of rotation (e.g. a creep spindle, see EP-A-1074645).

The preferred manufacturing method consists of forming the cover elements 202 from plastic complete from one piece in an injection-moulding process. This is also possible if the rear wall 226 must be formed from a different material to the side walls 214, 216 and cover part 218, for example in order to give a specific colour to the alarm or call signal.

It would of course be possible for individual parts of the cover element to be formed on the basis of an individual optimum method, or from individual optimum (different) materials, and for these parts to be assembled in order to manufacture the element 202. The housings 212 could, for example, be manufactured individually and connected by intermediate parts to form a cover element. Such housings could, for example, be adhesively bonded to the intermediate parts.

The invention is not restricted to use in ring spinning machines, nor, in a ring spinning machine, to the scanning of the traveller.

FIG. 3A shows in diagrammatic form a further embodiment of the principle of the selective issue of an optical signal for user support. In the case of the housing 212, provision is made for the optical signal to be issued selectively inside a delimited space in the vicinity of the spinning position. Under certain circumstances, however, it is necessary for a signal to be issued “broad-spaced”, whereby the production of the signal in the immediate vicinity of the light source is no longer important, because in this space at least one other signal generator is present. These requirements pertain to the “section lamp”. A lamp of this type is not shown in FIG. 3 of this Application, but has been described in EP-A-1074645 in connection with FIG. 9 and FIG. 13 respectively in the text; see “Lamp SA” therein. The concept of the “section” as a unit for the design of the sensor carrier has been described in EP-A-1052314. Both EP-A-1052314 as well as EP-A-1074645 are in each case regarded as integral constituent parts of the present invention.

According to the concept described in EP-A-1074645, the section lamp of a given section lights up if at least one spinning position within this section presents a defect, such as a thread break, for example. The section lamp of the section concerned should as far as possible be readily identifiable from the machine end, even if the section affected is located in the middle of the machine. The light yield from the source should therefore be exploited as efficiently as possible in the preferred directions. A solution to this problem is shown in FIG. 3A.

In FIG. 3A the reference number 280 relates to the free front wall of the profile 200, see FIG. 3, with an inner surface IF and an outer surface AF. For each section, the front wall 280 of the profile or of the individual profile part respectively, is provided with a continuous circular hole 281, which accommodates the button-shaped body 282.

Located inside the profile is a printed circuit board P with a light emitting diode 282, which by means of suitable lead connections to the printed circuit board P can be excited such as to light up. This diode 283 represents the light source for the individual section lamp in each case.

The body 282 consists of a disk-shaped head part 284 and a cylindrical stem 285. The body 282 is for preference formed from one piece, and specifically in the preferred embodiment from a light-permeable plastic. The stem 265 is pushed through the hole 281, until the head part 284 comes in contact against the outer surface AF of the wall 280. The front face 286 of the stem 285 is then in the vicinity of the diode 283 and conducts practically all the light emitted from the diode into the stem 285. The cylindrical outer surface of the stem 285 now functions towards the interior as a mirror, so that the light entering over the front face 286 is conducted further in the longitudinal direction of the stem as far as the head part 284.

The head part 284 is hollowed out by a conical-shaped excavation 287. The base of the excavation 287 lies in the plane of the free-standing surface of the head part, and the tip lies in the plane of the surface which is in contact with the surface AF. The conical-shaped surface in turn forms a mirror, which bends the light emerging from the stem 286 through about 90°, so that this light is now conducted further approximately parallel to the surface AF. The light can then leave the body 282 over the cylindrical surface 289 of the head part, and is therefore readily visible in the longitudinal direction of the machine, but conversely is scarcely visible in the longitudinal direction of the stem 285. The invention is not restricted to the details of the embodiment according to FIG. 3A. The geometry of the body 282 can be adjusted to the lightwave length or the diffraction index of the material, in order to achieve the desired effects.

The invention therefore makes provision in this respect for a housing part for an optical display. This housing part comprises a light-permeable part (e.g. the stem 285), which is formed for the light transmission in a first direction (e.g. in the longitudinal direction of the longitudinal part). This direction runs on a reflection surface (e.g. the conical surface 287), which can deflect the light out of the first direction into a second preferred direction.

1. Sensor for scanning the state of a spinning position in a thread-processing machine, in particular a ring spinning machine, with a light beam transmitter (236) and a light beam receiver (238) for the absorption of light which is emitted by the transmitter (236) and reflected by a part (254, FIG. 9) in a working position (e.g. a spinning position) of the machine,
characterized in that
the transmitter (236) and the receiver (238) are carried by a common carrier (212).

2-33. (canceled)
